(19) United States
(12) Patent Application Publication
(10) Pub. No.: US 2007/0174679 A1
(43) Pub. Date: Jul. 26, 2007

(54) Method and apparatus for processing error information and injecting errors in a processor system

(75) Inventors: Nathan P. Chelstrom, Cedar Park, TX (US); Tilman Gloekler, Gaertringen (DE); Ralph C. Koester, Tuebingen (DE); Mack W. Riley, Austin, TX (US)

Correspondence Address: MARK P. KAHLER, 8101 VAILVIEW COVE, AUSTIN, TX, 78750, US

(73) Assignee: IBM Corporation, Austin, TX (US)

(21) Appl. No.: 11/340,448

(22) Filed: Jan. 26, 2006

(51) Int. Cl. G06F 11/00

(52) U.S. Cl. 714/8

(57) ABSTRACT

A method and apparatus are disclosed for injecting errors in the functional units of a processor system, and for observing non-injected errors that occur in those functional units. A local error handler layer provides error injection for the various functional units at a local level. A global fault isolation register (FIR) layer couples to the local error handler layer to coordinate the handling of local errors in the multiple functional units of the processor system. A software debugger application or system software communicates with the global FIR layer to control error handling.

### TECHNICAL FIELD OF THE INVENTION

The disclosures herein relate generally to processors, and more particularly, to injecting errors in processors for testing purposes.

### BACKGROUND

The complexity of processor design continues to increase year after year at a dramatic pace. Error testing and hardware verification likewise continue to gain in importance for these increasingly complex structures. One approach to error testing is the familiar Joint Test Action Group (JTAG) interface which many processors and other integrated circuits employ. The JTAG interface uses boundary scan techniques to test integrated circuits by incorporating a shift register into each chip under test. This enables the shifting of input signals in and the shifting of output signals out of the chip via 4 I/O pins, namely input data, output data, clock and mode control. The JTAG approach obviated the former requirement for expensive, customized bed-of-nails type probe testing arrays.

In a typical processor test scenario, a debugger program or tool communicates with the JTAG interface on an integrated circuit. The debugger program instructs the JTAG interface with test input information regarding the tests conducted in the integrated circuit. When the integrated circuit completes the prescribed tests, the debugger program collects the resultant test output information from the JTAG interface on the integrated circuit.

Integrated circuits may include error injection circuitry that intentionally introduces errors into the various functional blocks or functional units that form an integrated circuit. Integrated circuits may also include fault isolation registers (FIRs) that collect information regarding errors that occur in the functional blocks of the integrated circuit. As the size and complexity of integrated circuits increase, management of error injection and collect of error information becomes increasingly difficult. Moreover, different integrated circuits often employ very different approaches to error injection, error collection and interpretation of error information. This tends to slow the integrated circuit design process.

What is needed is a method and apparatus that performs error injection in integrated circuits and that addresses the problems described above.

### SUMMARY

Accordingly, in one embodiment, a method is disclosed for error handling in a processor system including a plurality of local functional units. The method includes storing error information locally in respective local fault isolation registers coupled to the local functional units. The method also includes generating, by a test instruction source, test instructions relating to errors associated with the local functional units. The method further includes providing a global fault isolation layer between the test instruction source and the local fault isolation registers. In this manner, a user of a test instruction source, such as a debugger, need not have an intricate knowledge of the local error handling of the local functional units.

In another embodiment, a processor system is disclosed including a plurality of local functional units that store error information locally in respective local fault isolation registers coupled to the local functional units. The processor system also includes a test instruction source that provides test instructions relating to errors associated with the functional units. The processor system further includes a global fault isolation layer coupling the test instruction source to the local fault isolation registers. Again, in this manner, a user of a test instruction source, such as a debugger, need not have an intricate knowledge of the local error handling of the local functional units.

### BRIEF DESCRIPTION OF THE DRAWINGS

The appended drawings illustrate only exemplary embodiments of the invention and therefore do not limit its scope because the inventive concepts lend themselves to other equally effective embodiments.

FIG. 1 shows a block diagram of the disclosed processor system.

FIG. 2 shows a block diagram of a local fault handler in the system of FIG. 1.

FIG. 3A shows a block diagram of a global fault handler of the system of FIG. 1.

FIG. 3B shows a representation of the selection field and the control field of a control register of the global fault handler of FIG. 3A.

FIG. 4 shows a flowchart that depicts operational flow in the disclosed processor system

FIG. 5 shows an information handling system that employs the disclosed processor system.

### DETAILED DESCRIPTION

The disclosed system processor system includes a hierarchical error detection, error injection and error handling capability. The term RAS (reliability, availability, serviceability) describes error handling in general. In one embodiment, the disclosed processor system employs hardware at a top level of a hierarchically organized RAS (error detection) environment within the system to inject errors at the top level.

The disclosed processor system employs a hierarchical RAS structure for error detection and failure analysis. In one embodiment of the disclosed processor system, several functional blocks from existing standalone chips integrate together on a common chip to form a so-called “system on a chip” or SOC. Examples of such functional blocks include structures such as processors, co-processors, L2 cache memories, bus interface units and other functional units. Each of these formerly stand-alone chips typically has its own different error handling mechanisms. The disclosed processor system integrates these functional blocks with their different error handling mechanisms on a common IC to form the SOC. The processor system employs a hierarchical approach to error detection and failure analysis. In one embodiment, the processor system may employ existing hardware and software-assisted recovery mechanisms from the respective functional blocks. Different error handling mechanisms associated with such different functional blocks connect to an upper hierarchy level of error detection and failure analysis within the processor system. The error handling hierarchy of the processor system includes an upper or top hierarchy level that may communicate with a standard test interface such as the JTAG interface. In this manner, the disclosed processor may accommodate different error handling and recovery mechanisms in a common SOC.

While the disclosed processor can accommodate the different error handling and recovery mechanisms of different respective functional units in a single SOC, this hierarchical approach does increase the test complexity of the resultant SOC with respect to chip verification and “bring-up”. The term “verification” means verifying hardware, such as the disclosed processor, in a simulation environment before the hardware really exists, i.e. before the hardware is actually manufactured. “Bring-up” is the test of the real, manufactured and assembled system hardware including, for example, different integrated circuit chips, memories and boards in interaction with written and developed systems' software and firmware. In one embodiment, the disclosed processor's testing mechanisms include effectively degating lower hierarchical levels and emulation of error injection at the top level of the error handling hierarchy. The top level of the error handling hierarchy couples to a JTAG interface that communicates with a debugger software application. This configuration facilitates integrated circuit chip verification and bring-up without a top-down knowledge of the entire system by a person conducting the test. Moreover, testing may commence even though some functional units are not complete or are otherwise unavailable during the design process. The disclosed processor includes software controlled hardware that provides error injection at the top level of the error handling hierarchy and effectively breaks off the top level of the hierarchy from lower levels of the hierarchy for testing purposes. In this manner, a person conducting a test of the disclosed processor need not understand error injection logic at all of the functional units at lower levels of the hierarchy.

As described above, when each functional unit includes its own unique error detection mechanism in a system on a chip (SOC), difficulties can arise in detecting errors from these multiple different sources which may also be called local error handlers. To address this problem a local error handler includes local error injection circuits for the respective functional units of the SOC. The local error handler stores error information in local fault isolation registers (FIRs) for the respective functional units. To enable the local error handler to effectively communicate with a hardware test interface such as, for example the JTAG interface, the disclosed system on a chip (SOC) includes a global error handler that interfaces the local error handler to a hardware test interface. The term “local error handler” corresponds to local fault handler. Similarly, the term “global error handler” corresponds to global fault handler.

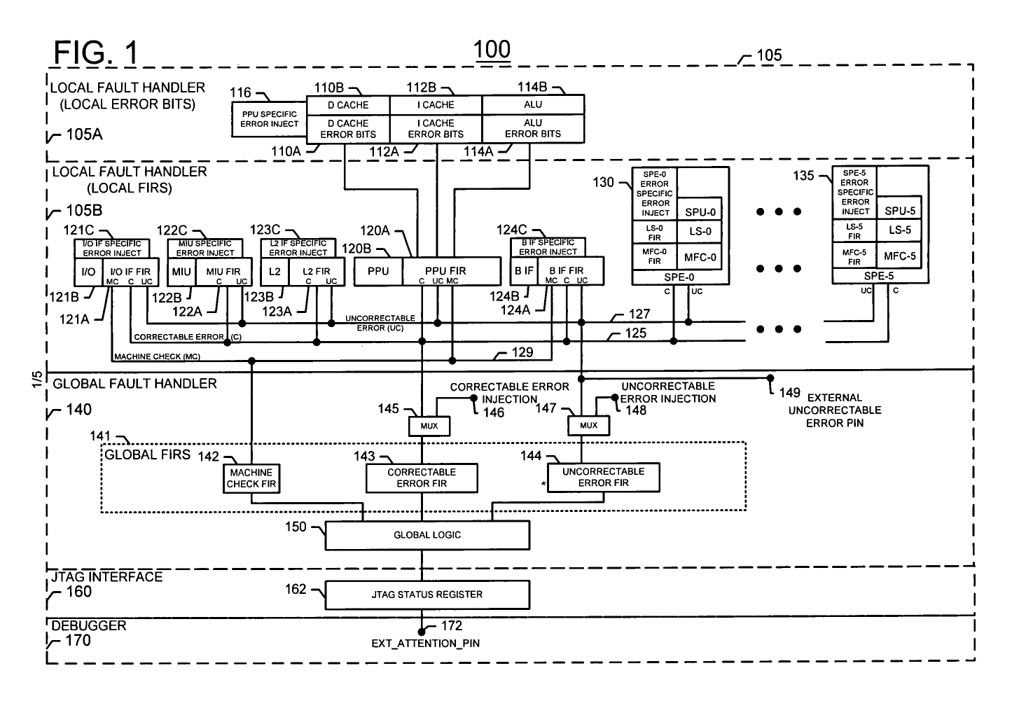

FIG. 1 shows one embodiment of the disclosed system on a chip (SOC) as SOC 100, namely system 100. System 100 includes a local fault handler 105 having a local fault handler section 105A for local error bits and a local fault handler section 105B for local fault isolation registers (FIRs). More specifically, local fault handler section 105A includes a data cache (D cache) error bit receiver 110A that couples to a D cache 110B, an instruction cache (I cache) error bit receiver 112A that couples to an I cache 112B and an arithmetic logic unit (ALU) error bit receiver 114A that couples to an ALU 114B. D cache 110B, I cache 112B and ALU 114B form representative functional units of system 100. Local fault handler section 105A includes a processor unit (PPU) specific error injection circuit 116 which can selectively inject errors into any of the error bit receivers thereof, namely D cache error bit receiver 11A, I cache error bit receiver 112A and ALU error bit receiver 114A.

Local fault handler 105B includes a processor unit (PPU) core fault isolation register (FIR) 120A that couples to a processor unit (PPU) 120B which is yet another functional unit of system 100, namely a main processor of the system. Local fault handler 105B further includes a local I/O FIR 121A, a local memory interface unit (MIU) FIR 122A, a local L2 cache FIR 123A and a local bus interface (B IF) FIR 124A that respectively couple to an I/O interface 121B, a memory interface unit 122B, an L2 cache memory 123B, and a bus interface 124B, and further respectively couple to a local I/O interface specific error injection circuit 121C, a local memory interface unit specific error injection circuit 122C, a local L2 cache interface error injection circuit 123C and a local bus interface error injection circuit 124C, as shown. D cache error bit receiver 110A, I cache error bit receiver 112A and ALU error bit receiver 114A couple to processor unit core FIR 120A as shown. Processor unit core FIR 120A couples to a processor core (PPU) 120B which is one of the functional units of system 100.

In FIG. 1, C designates correctable error, UC designates uncorrectable error and MC designates machine check. Local I/O FIR 121A, local MIU FIR 122A, local L2 cache FIR 123A, local processor unit core FIR 120A and local B IF FIR 124A each include a correctable error output (C) and an uncorrectable error output (UC) that couple to correctable error bus 125 and uncorrectable error bus 127, respectively. Local I/O FIR 121A, local processor unit core FIR 120A and local B IF FIR 124A also each include a machine check (MC) output that couples to machine check bus 129.

In the particular embodiment shown in FIG. 1, system 100 employs an architecture including 6 synergistic processor elements (SPEs), namely coprocessor devices, designated SPE-0, SPE-1 . . . SPE-5, of which FIG. 1 depicts SPE-0 and SPE-5. In actual practice, system 100 may employ a greater or lesser number of SPEs. The SPEs communicate with each other and PPU 120B via a common bus (not shown). More information regarding the particular architecture using a power processor unit (PPU) and multiple SPEs is found the publication “Cell Broadband Engine Architecture”, Version 1.0, published by the IBM Corporation on Aug. 8, 2005, the disclosure of which is incorporated herein by reference. This architecture is only exemplary of the possible processor architectures in which the illustrative embodiment may be implemented and the description of such in the following detailed description is not intended to state or imply any limitation with regard to the types of processor architectures in which the illustrative embodiment may be implemented. In one embodiment, PPU 120B may be a general purpose processor and SPE-0, . . . SPE-5 may be special or specific purpose processors. For convenience, FIG. 1 shows SPE-0 as device 130 and SPE-5 as device 135.

SPE-0 is representative of the SPEs employed by system 100. SPE-0 includes a synergistic processor unit, SPU-0, namely a processor, that couples to a local store, LS-0, and a memory flow control unit, MFC-0. In one embodiment, each SPE includes fault isolation registers, FIRs, that store and lock local error conditions. SPE-0 includes a local store fault isolation register, LS-0 FIR, coupled to local store LS-0. SPE-0 further includes a memory flow control fault isolation register, MFC-0 FIR, coupled to memory flow control, MFC-0. SPE-0 also includes an error specific error injection circuit, SPE-0 ERROR SPECIFIC ERROR INJECT, that couples to local store fault isolation register, LS-0, to inject errors therein. SPE-2 through SPE-5 exhibit substantially the same topology as SPE-0 described above. SPE-0, SPE-1, . . . SPE-5 each include correctable error outputs (C) and uncorrectable error outputs (UC) that couple to correctable error bus 125 and uncorrectable error bus 127, respectively.

A global fault handler 140 couples to local fault handler section 105B as shown to receive correctable error information, uncorrectable error information and machine check information therefrom. Global fault handler 140 provides a common or central location to collect local error information from the local FIRs 121A, 122A, 123A and 124A and also collect local error bit information from local error bit receivers 110A, 112A and 114A. Moreover, global fault handler 140 provides a layer of isolation between local fault handler 105 and debugger software 170 discussed below. Global fault handler 140 includes a global FIR section 141. Global FIR section 141 includes a global machine check FIR 142, a global correctable error FIR 143 and a global uncorrectable error FIR 144. Global machine check FIR 142 captures and stores machine check information received from machine check bus 129. Global correctable error FIR 143 couples to a multiplexer 145 that includes an input that couples to correctable error bus 125 and another input that couples to a correctable error injection port 146. In this manner, global fault handler 140 selectably supplies either an actual correctable error from local fault handler 105B or an injected correctable error from port 146 to the correctable error FIR 143.

Global uncorrectable error FIR 144 couples to a multiplexer 147 that includes an input that couples to uncorrectable error bus 127 and another input that couples to an uncorrectable error injection port 148. In this manner, global fault handler 140 selectably supplies either an uncorrectable error from local fault handler 105B or instead an injected uncorrectable error from port 148 to the uncorrectable error FIR 144. An external uncorrectable error pin 149 provides another port for the purpose of reporting system-wide uncorrectable errors to the SOC. In one embodiment, a system controller may apply a signal to pin 149 to stop any clocking signals in SOC 100 in case of a system emergency, such as for example a failing memory device detected by a memory controller.

Global fault handler 140 also includes global logic 150 that couples to global machine check FIR 142, global correctable error FIR 143 and global uncorrectable error FIR 144. Global logic 150 includes mask register functions and logic functions. Using these mask register functions, global logic 150 can mask any error reported from the local FIRs. Such masking may be helpful for debug and analysis purposes. Each local FIR, such as I/O IF FIR 121A and MIU FIR 122A, for example, includes an error counter (not shown). These counters in the local FIRs count every correctable error associated with the unit which couples to the FIR. Global fault handler 140 includes global logic 150 which controls this counting activity. This global logic 150 makes possible system performance measurements regarding correctable error occurrences and related error recovery. Global fault handler 140 may be set to different error modes as described below in more detail.

A JTAG interface 160 couples to global fault handler 140. The JTAG interface 160 includes control logic that couples JTAG interface 160 to global logic 150. Global logic 150 reports all errors to JTAG interface 160, coupled thereto. JTAG interface 160 includes a JTAG status register 162 that couples to global logic 150. In one embodiment, JTAG interface 160 may control global fault handler 140. A debugger 170 couples to JTAG interface 160 to instruct system 100 with respect to which error tests to be conducted, for example which errors to be injected by the error injection circuits thereof. JTAG status register 162 includes a plurality of bits wherein each bit corresponds to a different error occurrence, for example, one bit for machine check, one bit for correctable error and another bit for uncorrectable error. In one embodiment, JTAG status register 162 includes maskable bits. Debugger 170 includes an external attention pin 172 designated EXT_ATTENTION_PIN that represents the summation of all bits, namely the logic OR of all bits, of JTAG status register 162.

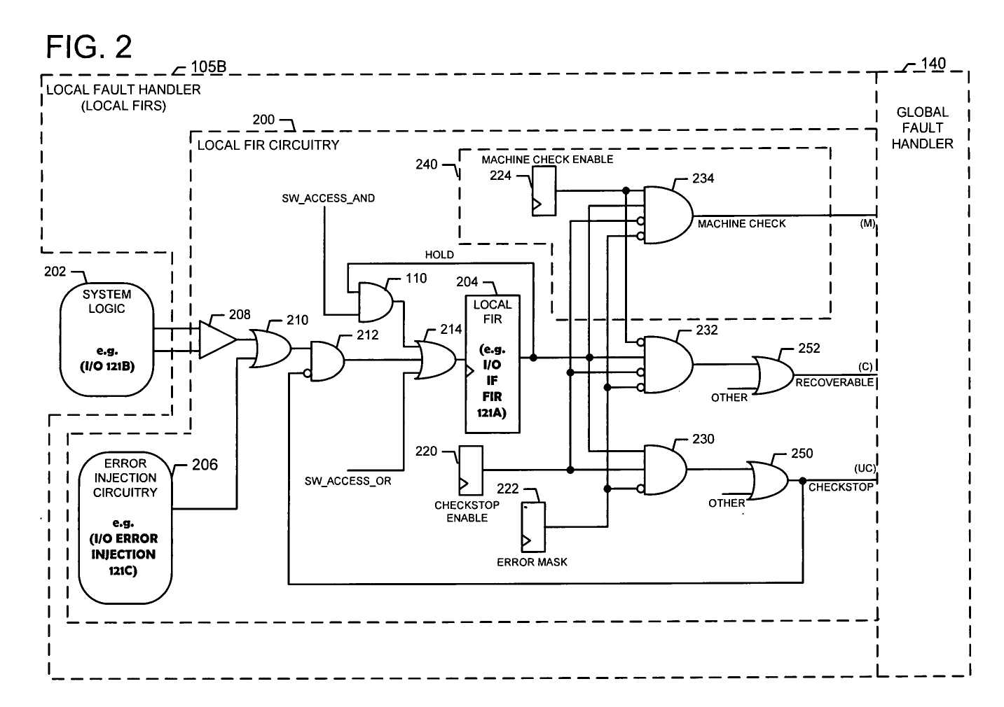

FIG. 2 depicts a schematic diagram of a portion of local fault handler 105B showing local FIR circuitry 200 applicable to each of the types of functional units in system logic 202. Local FIR circuitry 200 enables both local error injection and handling of non-injected errors. Non-injected errors are those errors that a particular functional unit produces without error injection. In one embodiment, system logic 202 includes functional units such as IO IF 121B, MIU 122B, L2 cache 123B and B IF 124B. System logic 202 further includes functional units such as PPU 120B and coprocessors SPE-0, SPE-1, . . . SPE-5. System 100 may provide a respective local FIR circuit 200 for each functional unit of system logic 202. In other words, a respective local FIR circuit 200 couples to each of these functional units to handle the errors of that functional unit. However, for purposes of example, FIG. 2 shows a representative local FIR circuit 200 configured to operate as an I/O interface (I/O IF) local FIR circuit. In this particular example, local FIR circuitry 200 includes a local FIR 204, namely I/O IF FIR 121A, coupled to system logic 202, namely I/O interface 121B, and error injection circuitry 206, namely I/O error injection circuitry 121C.

Returning now to the example of FIG. 2 wherein the functional unit of system logic 202 is I/O interface 121B, the I/O interface FIR 121A couples to both I/O interface 121B in system logic 202 to collect non-injected error information produced directly by I/O interface 121B and to I/O error injection circuitry 121C (error injection circuit 206) to collect error information relating to injected errors. An error detector 208 couples to system logic 202 to detect errors that system logic 202 generates. The output of error detector 208 couples to one input of an OR gate 210, the remaining input of which couples to error injection circuitry 206. Error injection circuitry 206 injects errors at an input of OR gate 210. In this manner, both natural non-injected errors occurring in system logic 202 and injected errors from error injection circuitry 206 propagate to local FIR 121A via OR gate 210, AND gate 212 and OR gate 214. Local FIR circuit 200 includes a checkstop enable configuration register 220, an error mask configuration register 222 and a machine check enable register 224 to configure local FIR circuitry 200 with checkstop, error mask and machine check functions, respectively. Local FIR circuitry 200 includes AND gates 230, 232 and 234 coupled to one another and registers 220, 222 and 224 as shown. Local FIR circuitry 200 includes a machine check section 240 that includes machine check enable register 224 and AND gate 234.

To configure FIR circuitry 200 to generate a checkstop error or unrecoverable error at output UC, system 100 programs checkstop enable register 220 with a logic high and error mask register 222 with a logic low. The remaining AND gate 230 input not coupled to registers 220 or 222 couples to the output of local FIR 204. The output of AND gate 230 couples via a two input OR gate 250 to output UC. The input of OR gate 250 not coupled to AND gate 230 receives other information such as any checkstop bits in local FIR 204. Similarly, system 100 may configure configuration registers 220, 222 and 224 to supply recoverable errors to output C. The system logic 202 provides an error without injection, namely a naturally occurring error. Initially, system 100 does not know what kind of error it is. Error mask register 222 and machine check enable register 224 help system 100 determine the type of error. Error mask register 222 determine the general system participation is error handling. For debug purposes, error mask register 222 can be enabled and disabled. Checkstop enable register 220 determines system 100 treats a particular error as an uncorrectable error or a correctable error. In one embodiment, the default value for checkstop enable register 220 is a “correctable” error. Machine check enable register 224 decides if a particular error participates as a “machine check” type of error or “correctable error”. A “machine check” type of error is a type of error for which system software handles the error and decides if the error is correctable by a recovery or the system needs to be stopped. System 100 may also configure configuration registers 220, 222 and 224 to supply machine checks at output M. System 100 may also configure configuration registers 220, 222 and 224 to supply the error contents of local FIR 204 to output C. As seen in FIG. 2, the local FIR circuitry 200 of local fault handler 105B supplies machine checks, recoverable errors and checkstops to global fault handler 140 via outputs M, C and UC. Referring now to FIG. 1, machine check FIR 142 collects and stores these machine checks; correctable error FIR 143 collects and stores these correctable errors, while uncorrectable error FIR 144 collects and stores uncorrectable errors.

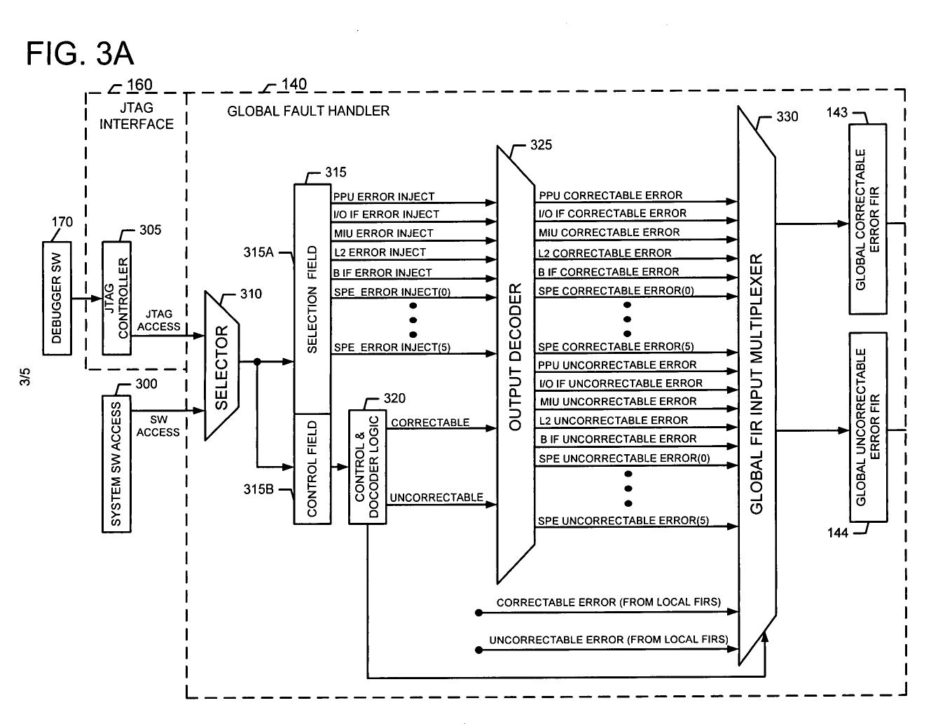

FIG. 3A shows more details of debugger software 170 and JTAG interface 160 which employ global fault handler 140 to instruct system 100 regarding which errors to collect and which errors to inject and store. Debugger software 170 and system software 300 may each access the error handling hierarchy of system 100. Debugger software 170 communicates with an input of selector 310 via a JTAG controller 305 in JTAG interface 160 therebetween. System software 300 communicates with another input of selector 305 as shown. In one embodiment, RISCWatch™ debugger software may be employed as system access software 300. (RlSCWatch is a trademark of the International Business Machines Corporation). As discussed above with reference to FIG. 2, system logic 202 may naturally generate errors as it operates. However, even though system logic 202 does not itself exhibit errors, system 100 can forcibly cause system logic 202 to exhibit an error by error injection. Returning now to FIG. 3A, system access software 300 may instruct global fault handler 140 to observe and collect non-injected errors, namely those natural, unforced errors that system logic 202 exhibits. Alternatively, system access software 300 may instruct global error injection logic in global fault handler 140 to inject an error directly to global error FIRs 143 or 144. Such global error injection logic includes control register 315, output decoder 325 and global input multiplexer 330 that are discussed in more detail below. The system access software 300 may also instruct global fault handler 140 to collect and store injected errors, namely forced errors that system logic 202 exhibits because of error injection. System access software 300 may instruct which particular functional unit is to exhibit which type of error. System access software 300 may also control other operating aspects of global fault handler 140 and local fault handlerlO5. Instead of system access software 300, debugger software 170 may also instruct global fault handler 140 to collect and store naturally occurring errors, or to inject errors and store results.

JTAG controller 305 and system software 300 couple to respective inputs of a selector 310 so that each may access a control register 315 that couples to the output of selector 310 as shown. Control register 315 includes a selection field section 315A and a control field section 315B. The register bits of selection field section 315A of FIG. 3A correspond to the section field bits illustrated in FIG. 3B which depicts the bit layout of register 315. The register bits of control field section 315B of FIG. 3A corresponding to the control field bits of FIG. 3B. In the selection field of FIG. 3B, bit 0 corresponds to the functional unit or block designated as PPU 120B, bit 1 corresponds to I/O 121 B, bit 2 corresponds to MIU 122B, bit 3 corresponds to L2 cache 123B, bit 4 corresponds to B IF 124B, bit 5 corresponds to coprocessor SPE-0, bit 6 corresponds to coprocessor SPE-1 , . . . and bit N corresponds to coprocessor SPE (5), wherein N=5. System software 300 may address any of these functional units or blocks by raising the logic state of the bit corresponding to that functional unit or block high. In one embodiment, control register 315 is an architected register that is accessible by system software like other architected registers of the system. Control register 315 is accessible via debugger 170, for example the RISCWatch™ debugger which includes a JTAG interface.

When system access software 300 or debugger software 170 so addresses a functional unit, the system access software or debugger software can also specify the type of error that system 100 should employ for that functional unit by specifying an appropriate bit in control field 315B. In this manner, system 100 controls the error type or mode currently employed. As seen in FIG. 3B, if debugger software 170 raises bit “I” high then system 100 injects an error in the currently addressed functional unit. If debugger software 170 sets the uncorrectable error bit “UE” to a high or logic 1, then system 100 injects or emulates an uncorrectable error for the currently addressed functional unit. However, if debugger software 170 sets the uncorrectable error bit “UE” to a low or logic 0, then system 100 injects or emulates a correctable error for the currently addressed functional unit. If debugger software 300 sets the reset bit “R” high or to a logic 1, then system 100 attempts a reset retry, namely a repeat of a previous operation attempt. Control and decoder logic 320 couples to control field section 315B and an output decoder 325. Logic 320 instructs output decoder 325 with respect to the type of error handling specified in the control field. Selection field section 315A couples to output decoder 325 to inform output decoder 325 regarding the particular functional unit for which system 100 should inject an error. To convey this functional unit selection information from control field section 315A to output decoder 325, global fault handler 140 includes a PPU error inject line, an I/O IF error inject line, an MIU error inject line; an L2 error inject line, a B IF error inject line and an SPE error inject (0) line, . . . SPE error inject (5) line.

Output decoder 325 couples to global FIR input multiplexer 330 via the following lines which specify either correctable or uncorrectable errors at designated respective functional units: PPU correctable error, I/O IF correctable error, MIU correctable error, L2 correctable error, B IF correctable error, SPE correctable error(0), . . . SPE correctable error (5). FIG. 3A depicts a similar set of lines between output decoder 325 and global FIR input multiplexer 330 for specifying the injection of uncorrectable errors. FIG. 3A also depicts global FIR input multiplexer 330 as coupled to both global correctable error FIR 143 and global uncorrectable error FIR 144. In actual practice, system 100 may bifurcate global fault handler 140 as follows. One set of control/decoder logic 320, output decoder 325 and multiplexer 330 may service global correctable error FIR 143 in a dedicated fashion, and another set of control/decoder logic 320, output decoder 325 and multiplexer 330 may service global uncorrectable error FIR 144 in a dedicated fashion. Thus, global FIR input multiplexer 330 actually include two separate multiplexers, namely multiplexer 145 which is dedicated to correctable error injection and multiplexer 147 which is dedicated to uncorrectable error injection, as shown in FIG. 1.

By way of example, to inject a correctable error in the functional unit referred to as I/O IF 123B, debugger software 170 activates selector 310 to connect the debugger to control register 315. Debugger software 170 then sets bit 1 of the selection field 315A to 1 and the UE bit of the control field 315B to 0. Control and decoder logic 320 interprets the control field and instructs output decoder 325 that debugger software 170 specified a correctable error. Decoder 325 interprets the bits of selection field 315A to determine that the debugger software specified the injection of an error in the I/O IF functional block 121B. Global FIR input multiplexer 330 then instructs the global correctable error FIR 143 with respect to the particular specified error. Global correctable error FIR 143 receives and stores the specified injected correctable error specified for the I/O IF functional block 121B. FIRs 143 and 144 immediately store any errors presented thereto. Global correctable error FIR 143 and global uncorrectable error FIR 144 each include a respective bit dedicated to each functional unit. Every correctable error, uncorrectable error or machine check error have one bit per functional unit allocated at the global level, namely at machine check FIR 142, correctable error FIR 143 and uncorrectable error FIR 144. As seen in FIG. 3A, global FIR input multiplexer 330, global correctable error FIR 143 and global uncorrectable error FIR 144 form part of global FIRS 141 of FIG. 1. In one embodiment, FIR 144 is a read only register and all other FIRs are read/write registers. FIG. 1 thus shows a read connection between the FIRS 141 of global fault handler 140 and JTAG interface 160, whereas FIG. 3A shows a write configuration for injecting errors.

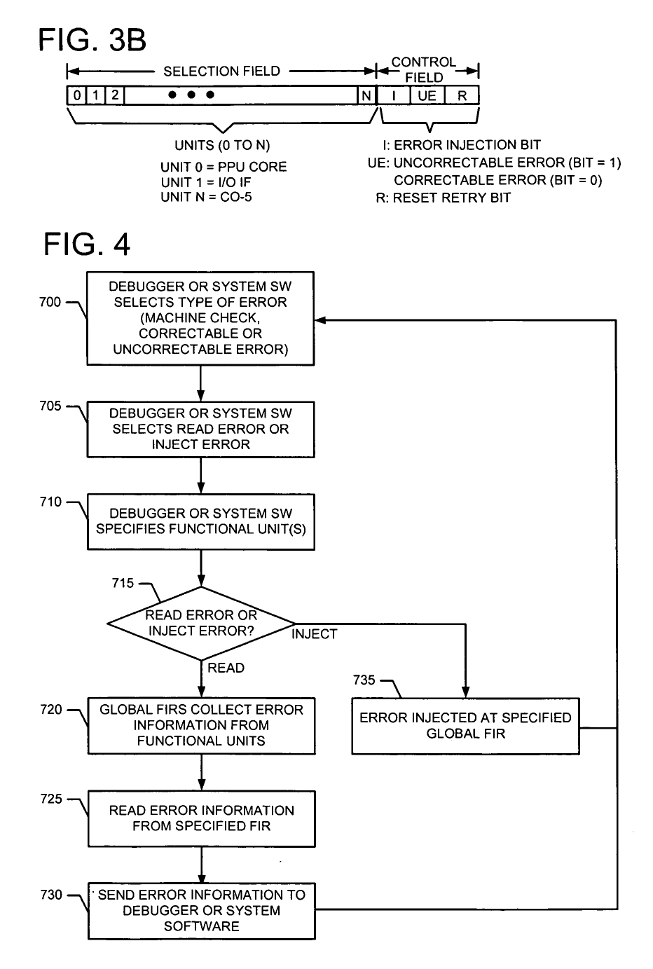

FIG. 4 shows a flowchart that depicts operational flow in one embodiment of system 100. A user of the debugger software 170 specifies a type of error of interest, as per block 700. For example the user may specify a machine check error, a correctable error or an uncorrectable error. In this particular example, the user specifies a correctable error. Alternatively, system software 300 may specify the type of error. The user then instructs the debugger software to either read a particular error or inject a particular error, as per block 705. For example, the user may specify reading an error. Alternatively, system software 300 may specify either a read or inject error operation. The user may then instruct the debugger software 170 regarding from which particular functional unit to read or derive the error information. For example, the user may specify the L2 cache functional unit 123B. System 100 conducts a test at decision block 715 to determine the selection of reading an error or injecting an error. If the user selected read an error, then process flow continues to block 720 at which the global FIRS 141 collect error information from the FIRs of the functional units coupled thereto. The global FIRs desirably insulate the user from needing to understand the inner workings of error collection and error handling at the local functional unit level. Since the user selected reading an uncorrectable error from the L2 cache functional unit, the system accesses the uncorrectable error information collected and stored in the global FIR 144, namely the global FIR dedicated to storing the uncorrectable errors of the functional units. In particular, the system accesses and reads the uncorrectable error information that uncorrectable error global FIR 144 stores from the L2 cache functional unit, as per block 725. Global FIR 144 sends this information to debugger 170 or system software 300, as per block 730. Process flow then continues back to block 700 at which the user may initiate a new request for error handling activities. If instead of specifying the reading of an error at block 705, the user instead specified injecting an error, then at decision block 715 process flow would continue to block 735. At block 735, the system would inject or write an error to the portion of global uncorrectable error FIR 144 dedicated to handling errors for the L2 cache functional unit specified by the user in block 710. Process flow then continues back to block 700. The user may then instruct the system to monitor selected global FIRS to see the results of the injected error. The user or programmer may use system software at 300 to inject an uncorrectable error into system 100. In this event, the read branch of the flowchart, namely blocks 720, 725 and 730, ceases to function because any clocks in the system stop immediately when the system encounters the uncorrectable error. Stopped clocks result in system registers being not accessible to system software. In this event, the user or programmer uses the RISCwatch™ debugger interface to access system registers to obtain error information.

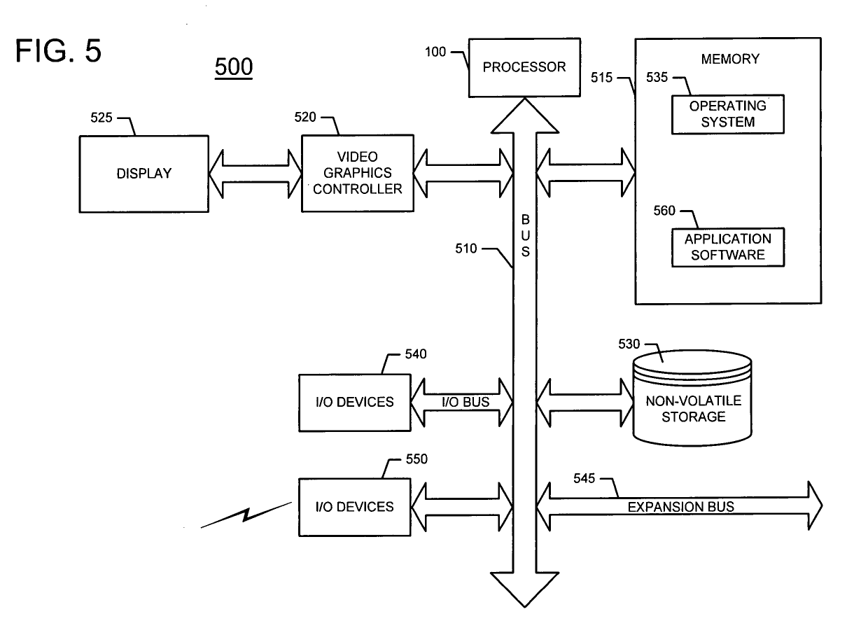

FIG. 5 shows an information handling system (IHS) 500 that employs system 100 as a processor for the IHS. IHS 500 further includes a bus 510 that couples processor 100 to system memory 515 and video graphics controller 520. A display 525 couples to video graphics controller 520. Nonvolatile storage 530, such as a hard disk drive, CD drive, DVD drive, or other nonvolatile storage couples to bus 510 to provide IHS 500 with permanent storage of information. An operating system 535 loads in memory 515 to govern the operation of IHS 500. I/O devices 540, such as a keyboard and a mouse pointing device, couple to bus 510. One or more expansion busses 545, such as USB, IEEE 1394 bus, ATA, SATA, PCI, PCIE and other busses, couple to bus 510 to facilitate the connection of peripherals and devices to IHS 500. A network adapter 550 couples to bus 510 to enable IHS 500 to connect by wire or wirelessly to a network and other information handling systems. While FIG. 5 shows one IHS that employs processor 100, the IHS may take many forms. For example, IHS 500 may take the form of a desktop, server, portable, laptop, notebook, or other form factor computer or data processing system. IHS 500 may take other form factors such as a gaming device, a personal digital assistant (PDA), a portable telephone device, a communication device or other devices that include a processor and memory.

The foregoing discloses a processor that injects errors at a local and global level to provide error testing for multiple different functional units.

Modifications and alternative embodiments of this invention will be apparent to those skilled in the art in view of this description of the invention. Accordingly, this description teaches those skilled in the art the manner of carrying out the invention and is intended to be construed as illustrative only. The forms of the invention shown and described constitute the present embodiments. Persons skilled in the art may make various changes in the shape, size and arrangement of parts. For example, persons skilled in the art may substitute equivalent elements for the elements illustrated and described here. Moreover, persons skilled in the art after having the benefit of this description of the invention may use certain features of the invention independently of the use of other features, without departing from the scope of the invention.

What is claimed is:

1. A method of error handling in a processor system including a plurality of local functional units, the method comprising:
storing error information locally in respective local fault isolation registers coupled to the local functional units;
generating, by a test instruction source, test instructions relating to errors associated with the local functional units; and
providing a global fault isolation layer between the test instruction source and the local fault isolation registers.

2. The method of claim 1, wherein the global fault isolation layer includes at least one of a correctable error fault isolation register, an uncorrectable error fault isolation register and a machine check register.

3. The method of claim 1, further comprising selecting, by the test instruction source, at least one of a correctable error, an uncorrectable error and a machine check error as the test instructions.

4. The method of claim 3, further comprising selecting, by the test instruction source, a read error operation to be performed by the global fault isolation layer.

5. The method of claim 3, further comprising selecting, by the test instruction source, an error injection operation to be performed by the global fault isolation layer.

6. The method of claim 1, further comprising receiving error information, by the global fault isolation layer, from the local fault isolation registers.

7. The method of claim 6, further comprising storing, by at least one global fault isolation register in the global fault isolation layer, the error information received from the local fault isolation registers.

8. The method of claim 1, wherein the test instruction source comprises debugger software.

9. The method of claim 1, wherein the test instruction source comprises system software.

10. A processor system comprising
a plurality of local functional units that store error information locally in respective local fault isolation registers coupled to the local functional units;
a test instruction source that provides test instructions relating to errors associated with the functional units; and
a global fault isolation layer coupling the test instruction source to the local fault isolation registers.

11. The processor system of claim 10, wherein the global fault isolation layer includes at least one of a correctable error fault isolation register, an uncorrectable error fault isolation register and a machine check register.

12. The processor system of claim 10, wherein the test instruction source selects at least one of a correctable error, an uncorrectable error and a machine check error as the test instructions.

13. The processor system of claim 12, wherein the test instruction source selects a read error operation to be performed by the global fault isolation layer.

14. The processor system of claim 12, wherein the test instruction source selects an error injection operation to be performed by the global fault isolation layer.

15. The processor system of claim 10, wherein the global fault isolation layer receives error information from the local fault isolation registers.

16. The processor system of claim 15, wherein at least one global fault isolation register in the global fault isolation layer stores the error information received from the local fault isolation registers.

17. The processor system of claim 10, wherein the test instruction source comprises debugger software.

18. The processor system of claim 10, wherein the test instruction source comprises system software.

19. An information handling system (IHS) comprising;
a memory;
a processor, coupled to the memory, the processor including:
a plurality of local functional units that store error information locally in respective local fault isolation registers coupled to the local functional units;
a test instruction source that provides test instructions relating to errors associated with the functional units; and
a global fault isolation layer coupling the test instruction source to the local fault isolation registers.

20. The IHS of claim 19, wherein the global fault isolation layer includes at least one of a correctable error fault isolation register, an uncorrectable error fault isolation register and a machine check register.
